(19) United States
(12) Patent Application Publication
(10) Pub. No.: US 2022/0279843 A1
(43) Pub. Date: Sep. 8, 2022

(54) AEROSOL-GENERATING DEVICE WITH GAP BETWEEN ARTICLE

(71) Applicant: PHILIP MORRIS PRODUCTS S.A., Neuchatel (CH)

(72) Inventors: Michel Bessant, Neuchatel (CH); Frederic Lavanchy, Chavornay (CH); Johannes Petrus Maria Pijnenburg, Neuchatel (CH); Jun Wei Yim, Colombier (CH)

(21) Appl. No.: 17/638,386

(22) PCT Filed: Sep. 4, 2020
(86) PCT No.: PCT/EP2020/074856

§ 371 Date: Feb. 25, 2022

(30) Foreign Application Priority Data
Sep. 6, 2019 (EP) 19195958.4

(51) Int. Cl. A24F 40/40; A24D 1/20; A24F 40/20

(52) U.S. Cl. CPC A24F 40/40; A24D 1/20; A24F 40/20

(57) ABSTRACT

The invention relates to an aerosol-generating system comprising an aerosol-generating device and an aerosol-generating article comprising aerosol-forming substrate. The aerosol-generating device comprises a cavity. The cavity is configured to receive the aerosol-generating article comprising aerosol-forming substrate. The device further comprises a mouthpiece configured to close the cavity. The aerosol-generating device is configured such that a gap is provided between the mouthpiece and the aerosol-generating article when the aerosol-generating article is received in the cavity and the mouthpiece is closed.

The present invention relates to an aerosol-generating device and an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A mouthpiece may be provided for closing the cavity, when the aerosol-generating article is received in the cavity. A user may draw on the mouthpiece. A heating element may be arranged in or around the heating chamber for heating the aerosol-forming substrate once the aerosol-generating article is inserted into the heating chamber of the aerosol-generating device.

In a conventional aerosol-generating device, after a usage session, an article's integrity may be compromised due to the heating of the aerosol-generating article. This might make removal of the aerosol-generating article difficult. There may be a risk that the aerosol-generating article breaks upon removal of the aerosol-generating article.

Conventional aerosol-generating devices might not have a mouthpiece as part of the device and instead the effective mouthpiece may be a filter end of the aerosol generating article. Articles may remain in a pack open for some time and exposed to e.g. a user's pocket, air, a user's bag, other users sharing from the packet etc. it might be less hygienic to puff on the filter end of the aerosol-generating article directly than to puff on a mouthpiece of the aerosol-generating device.

Ambient air is generally drawn into an airflow channel. The airflow channel may comprise the heating chamber, the aerosol-generating article and the mouthpiece. The air may be drawn through the airflow channel towards the user. During use, the entirety of incoming air may not be drawn through the aerosol-generating article. This may occur, for example, due to a gap between the aerosol-generating article and the sidewall of the heating chamber. Such a gap may result in some air escaping the heating chamber without passing through the aerosol-generating article and becoming entrained with volatilised aerosol-forming substrate. This may result in reduced aerosol delivery to the user. Such a gap may result in generated aerosol escaping from the heating chamber without passing through a mouthpiece element of the aerosol-generating device or of the aerosol-generating article for delivery to a user. This may result in reduced aerosol delivery to the user. The gap may be a result of manufacturing tolerances. The gap may be a result of thermal deformation of parts of the aerosol-generating device or of the aerosol-generating article during use. The gap may negatively influence the heating efficiency due to a part of the airflow being lost through the gap between the aerosol-generating article and the heating chamber.

Furthermore, air may be unintentionally drawn into the airflow channel through a gap between the mouthpiece and the cavity of the aerosol-generating device. This air may be directly drawn into the mouthpiece and towards the user without being drawn through the aerosol-generating article. Again, this airflow may negatively influence the heating efficiency.

It would be desirable to provide an aerosol-generating system with improved integrity and easier stick removal. It would be desirable to provide an aerosol-generating system with improved heating efficiency. It would be desirable to provide an aerosol-generating system, in which all incoming ambient air is drawn through a received aerosol-generating article. It would be desirable to provide an aerosol-generating system with improved hygiene.

According to an embodiment of the invention there is provided an aerosol-generating system comprising an aerosol-generating device and an aerosol-generating article comprising aerosol-forming substrate. The aerosol-generating device may comprise a cavity. The cavity may be configured to receive the aerosol-generating article comprising aerosol-forming substrate. The device may further comprise a mouthpiece configured to close the cavity. The aerosol-generating device may be configured such that a gap is provided between the mouthpiece and the aerosol-generating article when the aerosol-generating article is received in the cavity and the mouthpiece is closed.

According to an embodiment of the invention there is provided an aerosol-generating system comprising an aerosol-generating device and an aerosol-generating article comprising aerosol-forming substrate. The aerosol-generating device comprises a cavity. The cavity is configured to receive the aerosol-generating article comprising aerosol-forming substrate. The device further comprises a mouthpiece configured to close the cavity. The aerosol-generating device is configured such that a gap is provided between the mouthpiece and the aerosol-generating article when the aerosol-generating article is received in the cavity and the mouthpiece is closed.

In some embodiments, the gap may be a gap between an end face of the aerosol-generating article and the mouthpiece. The end face of the aerosol-generating article may be a downstream end face. The gap may be such that an end portion of the aerosol-generating article is not in contact with the mouthpiece. The end portion may be a downstream end portion. In some embodiments, the mouthpiece comprises a recessed region. The recessed region of the mouthpiece may provide the gap between and end face of the aerosol-generating article and the mouthpiece.

The gap between the downstream end face of the aerosol-generating article and the mouthpiece may act as a cooling feature. Air or aerosol exiting the downstream end face of the aerosol-generating article may flow into the gap and subsequently flow into the mouthpiece. While flowing through the gap, the air or aerosol may cool down. As a consequence, the aerosol-generating article may be of a simpler construction. In conventional aerosol-generating articles, a cooling section such as a hollow acetate tube cooling section may be necessary at a downstream portion of the aerosol-generating article.

Such a section may not be necessary in the aerosol-generating system according to the present invention due to the provisioning of the gap between the aerosol-generating article at the mouthpiece.

Providing the gap between the downstream end face of the aerosol-generating article and the mouthpiece may improve aerosol generation. The cooling of the air flowing through the may improve aerosol generation. Particularly, if the mouthpiece comprises a Venturi element as described in more detail below, cooling of the air flowing through the gap may synergistically improve aerosol generation within the Venturi element of the mouthpiece.

The gap between the mouthpiece and the inserted aerosol-generating article, when the mouthpiece is closed, may improve hygiene. A user may draw on the mouthpiece without the need of drawing directly on the aerosol-generating article. The aerosol-generating article may have been in a pack together with multiple further aerosol-generating articles. Such a pack may be open after an initial usage. After opening a pack of articles, the pack may lie around for a considerable amount of time, for example in a bag or pocket of the user. Consequently, a user may prefer to draw directly on the mouthpiece instead of on the aerosol-generating article.

Further, the gap may ensure structural integrity of the aerosol-generating article. During closing of the mouthpiece, the aerosol-generating article is not damaged or deformed due to the gap being provided between the aerosol-generating article and the mouthpiece, when the mouthpiece is closed. Structural integrity of the aerosol-generating article may improve usage experience. Structural integrity of the aerosol-generating article may facilitate ease of removal of the aerosol-generating article after use.

The gap between the mouthpiece and the aerosol-generating article may improve airflow through the aerosol-generating article into the mouthpiece. The gap may prevent clogging or obstruction of the downstream end face of the aerosol-generating article, when the mouthpiece is closed. The gap may facilitate that the air may freely flow out of the downstream end face of the aerosol-generating article into the mouthpiece. When the aerosol-generating article is inserted into the cavity of the aerosol-generating device and the mouthpiece is closed, the aerosol-generating article may be surrounded by the cavity of the main body of the aerosol-generating device and by the mouthpiece. In other words, the aerosol generating article may be encompassed by the cavity of the aerosol-generating device and the mouthpiece.

The aerosol-generating device may further comprise a sealing element. The sealing element may be sealingly arranged between the cavity and the mouthpiece. Advantageously, this may prevent airflow from an external environment into the device via a boundary between the cavity and the mouthpiece, when the mouthpiece is closed.

The sealing element may be arranged surrounding the downstream end of the cavity.

The sealing element may be arranged at the downstream end of the cavity. The sealing element may be arranged at a downstream end face of the cavity. The sealing element may be mounted downstream of the cavity. The sealing element may be mounted in a groove. The groove may be arranged in a downstream end face of the cavity. The downstream end face of the cavity may be circular. The sealing element arranged at the downstream end face of the cavity may be the most downstream point of the aerosol-generating device except for the mouthpiece. The downstream end face of the cavity may be shaped like the downstream end face of a hollow cylinder. The sealing element may fully cover the downstream end face of the cavity. Preferably, the sealing element partially covers the downstream end face of the cavity. The sealing element may be arranged at an inner circumference of the downstream end face of the cavity. The sealing element may be arranged at an outer circumference of the downstream end face of the cavity. When an aerosol-generating article is inserted into the cavity and the mouthpiece is closed, the sealing element may not contact the aerosol-generating article. The sealing element may be arranged adjacent to the outer circumference of the aerosol-generating device. The cavity of the aerosol-generating device may be centrally arranged in the aerosol-generating device. The aerosol-generating article may be inserted centrally into the aerosol-generating device. The sealing element may have a diameter larger than the diameter of the aerosol-generating article. The sealing element may have a diameter considerably larger than the diameter of the aerosol generating article. The sealing element may be disposed concentrically with an opening of the cavity. The sealing element may have a larger diameter than the diameter of the opening of the cavity. The sealing element may extend around a perimeter of the opening of the cavity.

Advantageously, the seal provides a seal between the aerosol-generating device main body and the mouthpiece. Consequently, ambient air from an external environment cannot enter the cavity of the aerosol-generating device from a boundary between the aerosol-generating device and the mouthpiece.

The sealing element may comprise foam. The sealing element may comprise compressible foam. The sealing element may consist of foam. The sealing element may consist of compressible foam.

More than one sealing element may be provided. Multiple sealing elements may be provided.

The sealing element may be circular. The sealing element may be ring-shaped. The sealing element may be configured as an O-ring. The sealing element may have a circular cross-section. The sealing element may have a rectangular cross-section. The sealing element may comprise thermo-resistant material. The sealing element may consist of thermo-resistant material.

During operation, the aerosol-generating article is inserted into the cavity of the main body of the aerosol-generating device and the mouthpiece is closed. Due to the sealing element being arranged between the main body of the aerosol-generating device and the mouthpiece, air cannot be drawn, from outside the aerosol-generating device, into the aerosol-generating device via the interface or boundary between the mouthpiece and the main body of the aerosol-generating device.

In use, a user may draw on the mouthpiece. When the user draws on the mouthpiece, ambient air is drawn into the aerosol-generating device through an air inlet of the aerosol-generating device. In some embodiments, the air inlet may be provided on an upstream end of the aerosol-generating device. In some embodiments, the air inlet may be provided on an upstream end face of the aerosol-generating device. The ambient air is drawn through the aerosol-generating device into the cavity at the upstream end of the cavity. The air is drawn through the aerosol-generating article. After exiting the downstream end of the aerosol-generating article, the air is drawn through the mouthpiece. At the downstream end of the mouthpiece, the air may be drawn into the mouth of the user.

Providing the sealing element between the cavity and the mouthpiece encourages air to flow through the aerosol-generating article received in the cavity. Providing the sealing element between the cavity and the mouthpiece helps to prevent ambient air from an environment external to the device from being drawn into the cavity through a gap between the cavity and the mouthpiece.

The cavity may be a heating chamber. The cavity may have a cylindrical shape. The cavity may have a hollow cylindrical shape. The cavity may have a circular cross-section. If desirable, the cavity may have a shape deviating from a cylindrical shape or a cross-section deviating from a circular cross-section. The cavity may have a shape corresponding to the shape of the aerosol-generating article to be received in the cavity. The cavity may have an elliptical or rectangular cross-section. The cavity may have a base at an upstream end of the cavity. The base may be circular. One or more air inlets may be arranged at or adjacent the base. An airflow channel may run through the cavity. Ambient air may be drawn into the aerosol-generating device, into the cavity and towards the user through the airflow channel. Downstream of the cavity, the mouthpiece may be arranged. The airflow channel may extend through the mouthpiece.

The mouthpiece may comprise a Venturi element. Within the mouthpiece, an airflow channel may be provided. The diameter of the airflow channel of the mouthpiece may gradually increase in a downstream direction. In other words, the diameter of the airflow channel may gradually increase in a direction away from a main body of the aerosol-generating device. The diameter of the airflow channel may gradually decrease in an upstream direction. In other words, the diameter of the airflow channel may gradually decrease towards the main body. The mouthpiece may be configured to utilize the Venturi effect. The mouthpiece may have a shape such that the Venturi effect occurs, when fluid flows through the mouthpiece.

The Venturi effect is the reduction of the pressure of a fluid during flow of the fluid through a constricted airflow passage. An upstream portion of the airflow channel near the main body may be configured as the constricted airflow passage.

The airflow channel of the mouthpiece may comprise a Venturi portion, wherein the Venturi portion may comprise an inlet portion, an optional central portion and an outlet portion. The inlet portion may be configured converging in a downstream direction and the outlet portion may be configured diverging in a downstream direction. In that way, the optional central portion of the Venturi portion is the portion with the smallest diameter between the inlet portion and the outlet portion. In some embodiments there is no central portion and the inlet portion and the outlet portion abut each other directly. In this case, the term “central portion” may be used to refer to constricted airflow passage of the Venturi portion, even if physically the inlet portion and the outlet portion touch in that cross section. In these embodiments the length of the central cross section may be in principle zero.

The airflow channel may be a central airflow channel. The airflow channel may be a hollow airflow channel. The airflow channel may run along the longitudinal axis of the mouthpiece. The airflow channel may extend into the aerosol-generating device. The cavity may be part of the airflow channel. The airflow channel may run along the longitudinal axis of the aerosol-generating device. The airflow channel may run along the longitudinal axis of the main body of the aerosol-generating device. When the mouthpiece is engaged with the main body, the airflow channel of the mouthpiece may be fluidly connected to the airflow channel of the main body.

The mouthpiece may be pivotally connected to the aerosol-generating device, particularly to the main body of the aerosol-generating device. The mouthpiece may be connected to the aerosol-generating device by means of a hinge.

The hinge may extend perpendicular to the longitudinal axis of the mouthpiece. The hinge may comprise conventional connection means for connecting the hinge with the main body of the aerosol-generating device. The hinge may be integrally formed with the mouthpiece. The hinge may be configured such that the mouthpiece may be pivotally opened to enable the aerosol-generating article to be inserted into the cavity of the aerosol-generating device. After insertion of the aerosol-generating article, the mouthpiece may be pivotally closed by means of the hinge. During closing of the mouthpiece with the aerosol-generating device, a fluid connection may be established between the mouthpiece and the aerosol-generating article.

The mouthpiece may be configured to contact the sealing element of the aerosol-generating device. The mouthpiece may be configured to contact the sealing element of the aerosol generating device during closing of the mouthpiece. When the mouthpiece is closed, the sealing element may be sandwiched between the mouthpiece and the main body of the aerosol-generating device. The mouthpiece may be configured such that closing of the mouthpiece applies pressure to the sealing element thereby facilitating a secure sealing between the mouthpiece of the main body of the aerosol-generating device. The contact area of the mouthpiece between the mouthpiece and the main body of the aerosol-generating device may be circular. The contact area of the main body of the aerosol-generating device between the main body of the aerosol-generating device and the mouthpiece may be circular. The contact areas of the mouthpiece and of the main body of the aerosol-generating device may be configured correspondingly. The sealing element may be arranged in the contact area between the mouthpiece and the main body of the aerosol-generating device.

The device may comprise a second sealing element arranged at a sidewall of the cavity. The second sealing element may be arranged at a downstream portion of the cavity. The second sealing element may be arranged to provide a seal between the sidewall of the cavity and an aerosol-generating article when the aerosol-generating article is received in the cavity. The second sealing element may prevent airflow between the sidewall of the cavity and the aerosol-generating article. As a consequence, airflow may be forced through the aerosol-generating article. The second sealing element may be arranged to provide a circumferential seal between the sidewall of the cavity and an aerosol-generating article when the aerosol-generating article is received in the cavity.

The device may comprise a third sealing element arranged at an upstream portion of the cavity. The third sealing element may be arranged to provide a seal between the sidewall of the cavity and an aerosol-generating article when the aerosol-generating article is received in the cavity. The third sealing element may be arranged to provide a circumferential seal between the sidewall of the cavity and an aerosol-generating article when the aerosol-generating article is received in the cavity.

By providing the two additional sealing elements at a downstream portion and at an upstream portion of the cavity, respectively, airflow is forced through the aerosol-generating article before passing through a device outlet to a user. According to this embodiment, airflow is substantially prevented or completely prevented between the sidewall of the cavity and the aerosol-generating article between the two additional sealing elements. The distance between the two additional sealing elements is preferably essentially the entire length of a substrate portion of the aerosol-generating article received in the cavity. According to this embodiment, an aerosol-generating device is provided in which airflow is prevented from exiting the cavity other than through the aerosol-generating article.

One or both of the second and third sealing elements may comprise O-rings. One or both of the second and third sealing elements may be configured as O-rings. One or both of the second and third sealing elements may be mounted in respective grooves in the sidewall of the cavity. One or both of the second and third sealing elements may be ring-shaped. One or both of the second and third sealing elements may have a circular cross-section. One or both of the second and third sealing elements may have a rectangular cross-section. One or both of the second and third sealing elements may fully surround the cavity. Each of the second and third sealing elements may each be arranged to provide a circumferential seal between the sidewall of the cavity and an aerosol-generating article when the aerosol-generating article is received in the cavity. One or both of the second and third sealing elements may be arranged in a plane perpendicular to the longitudinal axis of the cavity. One or both of the second and third sealing elements may be arranged in a plane perpendicular to the longitudinal axis of the aerosol-generating device. One or both of the second and third sealing elements may comprise thermo-resistant material. One or both of the second and third sealing elements may consist of thermo-resistant material. One or both of the second and third sealing elements may have an inner diameter corresponding to or slightly smaller than the outer diameter of the aerosol-generating article. One or both of the second and third sealing elements may have an outer diameter corresponding to or slightly larger than the inner diameter of the sidewall of the cavity.

The sidewall of the cavity may surround the cavity. The sidewall may connect the base of the cavity at the upstream end of the cavity and the downstream end of the cavity. The downstream end of the cavity may be open. The open downstream end may be configured for insertion of the aerosol-generating article. The upstream end of the cavity may abut the upstream end of the sidewall. The downstream end of the cavity may abut the downstream end of the sidewall.

In some embodiments, the aerosol-generating device comprises a heating element. In some embodiments, the aerosol-generating device comprises a power supply and a heating element. In some embodiments, the heating element comprises an external heating element. In some embodiments, the heating element comprises an internal heating element. In some embodiments, the heating element comprises both an internal heating element and an external heating element.

The power supply may be a battery. The power supply may be arranged in a main body of the aerosol-generating device. In some embodiments, the power supply is a Lithium-ion battery. In some embodiments, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the aerosol-generating device.

The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation. The internal heating element may be arranged in the cavity, preferably in the sense of the cavity. The internal heating element may be mounted at the base of the cavity.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The internal or external heating element may comprise a heat sink, or heat reservoir comprising a material capable of absorbing and storing heat and subsequently releasing the heat over time to the aerosol-forming substrate. The heat sink may be formed of any suitable material, such as a suitable metal or ceramic material. In one embodiment, the material has a high heat capacity (sensible heat storage material), or is a material capable of absorbing and subsequently releasing heat via a reversible process, such as a high temperature phase change. Suitable sensible heat storage materials include silica gel, alumina, carbon, glass mat, glass fibre, minerals, a metal or alloy such as aluminium, silver or lead, and a cellulose material such as paper. Other suitable materials which release heat via a reversible phase change include paraffin, sodium acetate, naphthalene, wax, polyethylene oxide, a metal, metal salt, a mixture of eutectic salts or an alloy. The heat sink or heat reservoir may be arranged such that it is directly in contact with the aerosol-forming substrate and can transfer the stored heat directly to the substrate. Alternatively, the heat stored in the heat sink or heat reservoir may be transferred to the aerosol-forming substrate by means of a heat conductor, such as a metallic tube.

The heating element advantageously heats the aerosol-forming substrate by means of conduction. The heating element may be at least partially in contact with the substrate, or the carrier on which the substrate is deposited. Alternatively, the heat from either an internal or external heating element may be conducted to the substrate by means of a heat conductive element.

During operation, the aerosol-forming article may be completely contained within the cavity of the aerosol-generating device. In that case, a user may puff on the mouthpiece of the aerosol-generating device.

In some embodiments, instead of, or in addition to, an electrically resistive heating element, the heating element may be configured as an induction heating element. The induction heating element may comprise an induction coil and a susceptor. In general, the susceptor is a material that is capable of absorbing electromagnetic energy and converting it to heat. When located in an alternating electromagnetic field, typically eddy currents are induced and hysteresis losses occur in the susceptor causing heating of the susceptor. Changing electromagnetic fields generated by one or several induction coils heat the susceptor, which then transfers the heat to the aerosol-generating article, such that an aerosol is formed. The heat transfer may be mainly by conduction of heat. Such a transfer of heat is best, if the susceptor is in close thermal contact with the aerosol-generating article.

The susceptor may be formed from any material that can be inductively heated to a temperature sufficient to generate an aerosol from the aerosol-forming substrate. A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptors are metal susceptors, for example stainless steel. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium.

Preferably, the susceptor material is a metallic susceptor material. The susceptor may also be a multi-material susceptor and may comprise a first susceptor material and a second susceptor material. In some embodiments, the first susceptor material may be disposed in intimate physical contact with the second susceptor material. The second susceptor material preferably has a Curie temperature that is below the ignition point of the aerosol-forming substrate. The first susceptor material is preferably used primarily to heat the susceptor when the susceptor is placed in a fluctuating electromagnetic field. Any suitable material may be used. For example the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Suitable materials for the second susceptor material may include nickel and certain nickel alloys.

By providing a susceptor having at least a first and a second susceptor material, the heating of the aerosol-forming substrate and the temperature control of the heating may be separated. Preferably the second susceptor material is a magnetic material having a second Curie temperature that is substantially the same as a desired maximum heating temperature. That is, it is preferable that the second Curie temperature is approximately the same as the temperature that the susceptor should be heated to in order to generate an aerosol from the aerosol-forming substrate.

When an induction heating element is employed, in some embodiments, the induction heating element may be configured as an internal heating element as described herein or as an external heater as described herein. If the induction heating element is configured as an internal heating element, the susceptor element is preferably configured as a pin or blade for penetrating the aerosol-generating article. If the induction heating element is configured as an external heating element, the susceptor element is preferably configured as a cylindrical susceptor at least partly surrounding the cavity or forming the sidewall of the cavity. In some embodiments, the susceptor may be provided as part of the aerosol-generating article. The susceptor may be provided as a plurality of susceptor particles, such as susceptor granules or susceptor flakes. The susceptor may be homogeneously dispersed within the aerosol-forming substrate of the aerosol-generating article. The susceptor may have regular or irregular shapes or surfaces, for example, may have a round or flat shape. The susceptor may be provided as susceptor beads or susceptor grit. The particles may be granules or flakes having a regular or irregular shape or surface, for example having a round or flat shape. The susceptor may be provided as a susceptor strip or susceptor strips. The susceptor may be provided as a central susceptor strip or susceptor bar within the aerosol-generating article.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

In some embodiments, operation of the heating element may be triggered by a puff detection system. In some embodiments, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through an airflow path of the aerosol-generating device per time by the user. The initiation of the puff may be detected by the airflow sensor when the airflow exceeds a predetermined threshold. Initiation may also be detected upon a user activating a button.

The sensor may be configured as a pressure sensor to measure the pressure of the air inside the aerosol-generating device which is drawn through the airflow path of the device by the user during a puff. The sensor may be configured to measure a pressure difference or pressure drop between the pressure of ambient air outside of the aerosol-generating device and of the air which is drawn through the device by the user. The pressure of the air may be detected at the air inlet, the mouthpiece of the device, the heating chamber or any other passage or chamber within the aerosol-generating device, through which the air flows. When the user draws on the aerosol-generating device, a negative pressure or vacuum is generated inside the device, wherein the negative pressure may be detected by the pressure sensor. The term “negative pressure” is to be understood as a pressure which is relatively lower than the pressure of ambient air. In other words, when the user draws on the device, the air which is drawn through the device has a pressure which is lower than the pressure off ambient air outside of the device. The initiation of the puff may be detected by the pressure sensor if the pressure difference exceeds a predetermined threshold.

As used herein, the terms ‘upstream’ and ‘downstream’ are used to describe the relative positions of components, or portions of components, of the aerosol-generating device in relation to the direction in which a user draws on the aerosol-generating device during use thereof. The term ‘downstream’ may refer to a position relatively closer to a mouth end. The term ‘upstream’ may refer to a position relatively further from the mouth end, preferably closer to an opposed end.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

The aerosol-generating article may comprise a wrapping paper wrapped around the outer circumference of the aerosol-generating article. The wrapping paper may be configured air impermeable.

The aerosol-generating article may comprise a substrate portion. The substrate portion may comprise the aerosol-forming substrate. The substrate portion may be arranged adjacent to an upstream end of the aerosol-generating article. The aerosol-generating article may further comprise a filter portion. The filter portion may be arranged adjacent to a downstream end of the aerosol-generating article. The wrapping paper may be configured at least partially surrounding the substrate portion and partly surrounding the filter portion such as to connect and hold together the two portions of the aerosol-generating article.

The aerosol-generating article may comprise a first sealing wrapper, wherein the first sealing wrapper partly covers the wrapping paper. The first sealing wrapper increases the diameter of the aerosol-generating article.

The first sealing wrapper may be ring-shaped. The first sealing wrapper may circumferentially or perimetrically surround the aerosol-generating article. The first sealing wrapper may circumferentially or perimetrically surround the wrapping paper. The first sealing wrapper may fully surround the outer circumference or perimeter of the aerosol-generating article. The first sealing wrapper may have a circular or rectangular cross-section. The first sealing wrapper may be made of a cigarette paper. The first sealing wrapper may have a high friction outer surface. The outer surface of the first sealing wrapper may comprise a high friction coating. The first sealing wrapper may be air impermeable. The first sealing wrapper may be configured as a coating.

The aerosol-generating article may comprise a second sealing wrapper, wherein the first sealing wrapper may be arranged at an upstream portion of the aerosol-generating article and the second sealing wrapper may be arranged at a downstream portion of the aerosol-generating article.

The second sealing wrapper may be ring-shaped. The second sealing wrapper may circumferentially or perimetrically surround the aerosol-generating article. The second sealing wrapper may circumferentially or perimetrically surround the wrapping paper. The second sealing wrapper may fully surround the outer circumference or perimeter of the aerosol-generating article. The second sealing wrapper may have a circular or rectangular cross-section. The second sealing wrapper may be made of a cigarette paper. The second sealing wrapper may have a high friction outer surface. The outer surface of the second sealing wrapper may comprise a high friction coating. The second sealing wrapper may be air impermeable. The second sealing wrapper may be configured as a coating.

The first sealing wrapper of the aerosol-generating article may be arranged to align with the second sealing element of the aerosol-generating device, when the aerosol-generating article may be received in the cavity of the aerosol-generating device. The first sealing wrapper of the aerosol-generating article may be arranged to contact the second sealing element of the aerosol-generating device, when the aerosol-generating article may be received in the cavity of the aerosol-generating device.

The first sealing wrapper of the aerosol-generating article may be arranged to align with the second sealing element of the aerosol-generating device, when the aerosol-generating article may be received in the cavity of the aerosol-generating device. The second sealing wrapper of the aerosol-generating article may be arranged to sealingly contact the third sealing element of the aerosol-generating device, when the aerosol-generating article may be received in the cavity of the aerosol-generating device.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped. The aerosol-generating article may have a total length between approximately 30 mm and approximately 100 mm. The aerosol-generating article may have an external diameter between approximately 5 mm and approximately 12 mm. The aerosol-generating article may comprise a filter plug in the filter portion. The filter plug may be located at a downstream end of the aerosol-generating article. The filter plug may be a cellulose acetate filter plug. The filter plug may have a length of between approximately 5 mm to approximately 15 mm. In some embodiments, the filter plug is approximately 7 mm in length.

In some embodiments, the aerosol-generating article has a total length of approximately 45 mm. The aerosol-generating article may have an external diameter of approximately 5.3 mm. The smaller the diameter of the substrate is, the lower is the temperature that is required to raise the core temperature of the aerosol-generating article such that sufficient amounts of material is release to form a desired amount of aerosol. At the same time, a small diameter allows for a fast penetration of the heat into the entire volume of aerosol-forming substrate. Nevertheless, where the diameter is too small, the volume to surface ratio of the aerosol-forming substrate becomes unattractive as the amount of available aerosol-forming substrate diminishes. A preferred range of diameter between 5 and 6 millimeters is particularly advantageous in terms of a balance between energy consumption and aerosol delivery. Further, the aerosol-forming substrate may have a length of approximately 10 mm. Alternatively, the aerosol-forming substrate may have a length of approximately 12 mm. Alternatively, the aerosol-forming substrate may have a length of between 10 mm and 32 mm, preferably around 22 mm. Further, the diameter of the aerosol-forming substrate may be between approximately 5 mm and approximately 12 mm. The aerosol-generating article may comprise an outer paper wrapper as the wrapping paper. Further, the aerosol-generating article may comprise a separation between the aerosol-forming substrate and the filter plug. The separation may be approximately 18 mm, but may be in the range of approximately 5 mm to approximately 25 mm.

Preferably, the aerosol-forming substrate comprises cut-filler. In this document, “cut-filler” is used to refer to a blend of shredded plant material, in particular leaf lamina, processed stems and ribs, homogenized plant material, like for example made into sheet form using casting or papermaking processes. The cut filler may also comprise other after-cut, filler tobacco or casing. According to preferred embodiments of the invention, the cut-filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves, however, the invention is equally applicable to other plant material that has the ability to release substances upon the application of heat that can subsequently form an aerosol.

Preferably, the tobacco plant material comprises lamina of one or more of bright tobacco lamina, dark tobacco, aromatic tobacco and filler tobacco. Bright tobaccos are tobaccos with a generally large, light coloured leaves. Throughout the specification, the term “bright tobacco” is used for tobaccos that have been flue cured. Examples for bright tobaccos are Chinese Flue-Cured, Flue-Cured Brazil, US Flue-Cured such as Virginia tobacco, Indian Flue-Cured, Flue-Cured from Tanzania or other African Flue Cured. Bright tobacco is characterized by a high sugar to nitrogen ratio. From a sensorial perspective, bright tobacco is a tobacco type which, after curing, is associated with a spicy and lively sensation. According to the invention, bright tobaccos are tobaccos with a content of reducing sugars of between about 2.5 percent and about 20 percent of dry weight base of the leaf and a total ammonia content of less than about 0.12 percent of dry weight base of the leaf. Reducing sugars comprise for example glucose or fructose. Total ammonia comprises for example ammonia and ammonia salts. Dark tobaccos are tobaccos with a generally large, dark coloured leaves. Throughout the specification, the term “dark tobacco” is used for tobaccos that have been air cured. Additionally, dark tobaccos may be fermented. Tobaccos that are used mainly for chewing, snuff, cigar, and pipe blends are also included in this category. Typically, these dark tobaccos are air cured and possibly fermented. From a sensorial perspective, dark tobacco is a tobacco type which, after curing, is associated with a smoky, dark cigar type sensation. Dark tobacco is characterized by a low sugar to nitrogen ratio. Examples for dark tobacco are Burley Malawi or other African Burley, Dark Cured Brazil Galpao, Sun Cured or Air Cured Indonesian Kasturi. According to the invention, dark tobaccos are tobaccos with a content of reducing sugars of less than about 5 percent of dry weight base of the leaf and a total ammonia content of up to about 0.5 percent of dry weight base of the leaf. Aromatic tobaccos are tobaccos that often have small, light coloured leaves. Throughout the specification, the term “aromatic tobacco” is used for other tobaccos that have a high aromatic content, e.g. of essential oils. From a sensorial perspective, aromatic tobacco is a tobacco type which, after curing, is associated with spicy and aromatic sensation. Example for aromatic tobaccos are Greek Oriental, Oriental Turkey, semi-oriental tobacco but also Fire Cured, US Burley, such as Perique, Rustica, US Burley or Meriland. Filler tobacco is not a specific tobacco type, but it includes tobacco types which are mostly used to complement the other tobacco types used in the blend and do not bring a specific characteristic aroma direction to the final product. Examples for filler tobaccos are stems, midrib or stalks of other tobacco types. A specific example may be flue cured stems of Flue Cure Brazil lower stalk.

The cut-filler suitable to be used with the present invention generally may resemble to cut-filler used for conventional smoking articles. The cut width of the cut filler preferably is between 0.3 millimeters and 2.0 millimeters, more preferably, the cut width of the cut filler is between 0.5 millimeters and 1.2 millimeters and most preferably, the cut width of the cut filler is between 0.6 millimeters and 0.9 millimeters. The cut width may play a role in the distribution of heat inside the substrate portion of the article. Also, the cut width may play a role in the resistance to draw of the article. Further, the cut width may impact the overall density of the substrate portion.

The strand length of the cut-filler is to some extent a random value as the length of the strands will depend on the overall size of the object that the strand is cut off from. Nevertheless, by conditioning the material before cutting, for example by controlling the moisture content and the overall subtlety of the material, longer strands can be cut. Preferably, the strands have a length of between about 10 millimeters and about 40 millimeters before the strands are formed into the substrate section. Obviously, if the strands are arranged in a substrate section in a longitudinal extension where the longitudinal extension of the section is below 40 millimeters, the final substrate section may comprise strands that are on average shorter than the initial strand length. Preferably, the strand length of the cut-filler is such that between about 20 percent and 60 percent of the strands extend along the full length of the substrate portion. This prevents the strands from dislodging easily from the substrate section. Alternatively or additionally, strand length may be controlled by the cutting process.

In preferred embodiments, the weight of the aerosol-forming substrate is between 59 milligrams and 190 milligrams, preferably between 70 milligrams and 170 milligrams, more preferably between 115 milligrams and 155 milligrams, most preferably around 132 milligrams. This amount of aerosol forming typically allows for sufficient material for the formation of an aerosol. Additionally, in the light of the aforementioned constraints on diameter and size, this allows for a balanced density of the aerosol-forming substrate between energy uptake, resistance to draw and fluid passageways within the substrate section where the substrate comprises plant material.

The aerosol-forming substrate may be soaked with aerosol former. Soaking the aerosol-forming substrate can be done by spraying or by other suitable application methods. The aerosol former may be applied to the blend during preparation of the cut-filler. For example, the aerosol former may be applied to the blend in the direct conditioning casing cylinder (DCCC). Conventional machinery can be used for applying an aerosol former to the cut-filler. The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example to: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Preferably, the aerosol former comprises one or more of glycerine and propylene glycol. The aerosol former may consist of glycerine or propylene glycol or of a combination of glycerine and propylene glycol.

Preferably, the amount of aerosol former is between 6 percent and 20 percent by weight on a dry weight basis of the aerosol-forming substrate, more preferably, the amount of aerosol former is between 8 percent and 18 percent by weight on a dry weight basis of the aerosol-forming substrate, most preferably the amount of aerosol former is between 10 percent and 15 percent by weight on a dry weight basis of the aerosol-forming substrate. For some embodiments the amount of aerosol former has a target value of about 13 percent by weight on a dry weight basis of the aerosol-forming substrate. The most efficient amount of aerosol former will depend also on the aerosol-forming substrate, whether the aerosol-forming substrate comprises plant lamina or homogenized plant material. For example, among other factors, the type of substrate will determine to which extent the aerosol-former can facilitate the release of substances from the aerosol-forming substrate.

For these reasons, the aerosol-forming substrate of the present invention may be capable of efficiently generating sufficient amount of aerosol at relatively low temperatures. A temperature of between 150 degrees Celsius and 220 degrees Celsius in the heating chamber may be sufficient for the aerosol-forming substrate to generate sufficient amounts of aerosol.

Alternatively or additionally, the aerosol-generating substrate may be impregnated with aerosol former. Providing homogenised tobacco material may improve aerosol generation, the nicotine content and the flavour profile of the aerosol generated during heating of the aerosol-generating article. Specifically, the process of making homogenised tobacco may involve grinding one or more of botanicals, tobacco leaf, tobacco root, tobacco flower and tobacco seeds, which more effectively enables the release of nicotine and flavours upon heating.

The homogenised tobacco material may be provided in sheets which are one of folded, crimped, or cut into strips. In a particularly preferred embodiment, the sheets are cut into strips having a width of between about 0.2 millimetres and about 2 millimetres, more preferably between about 0.4 millimetres and about 1.2 millimetres. In one embodiment, the width of the strips is about 0.9 millimetres.

Alternatively, the homogenised tobacco material may be formed into spheres using spheronisation. The mean diameter of the spheres is preferably between about 0.5 millimetres and about 4 millimetres, more preferably between about 0.8 millimetres and about 3 millimetres.

The aerosol-generating substrate preferably comprises: homogenised tobacco material between about 55 percent and about 75 percent by weight; aerosol-former between about 15 percent and about 25 percent by weight; and water between about 10 percent and about 20 percent by weight.

Before measuring the samples of aerosol-generating substrate they are equilibrated for 48 hours at 50 percent relative humidity at 22 degrees Celsius. The Karl Fischer technique is used to determine the water content of the homogenised tobacco material.

The aerosol-generating substrate may further comprise a flavourant between about 0.1 percent and about 10 percent by weight. The flavourant may be any suitable flavourant known in the art, such as menthol.

Sheets of homogenised tobacco material for use in aerosol-generating articles comprising a capsule may be formed by agglomerating particulate tobacco obtained by grinding or otherwise comminuting one or both of tobacco leaf lamina and tobacco leaf stems.

Sheets of homogenised tobacco material for use in aerosol-generating articles comprising a capsule may comprise one or more intrinsic binders that is a tobacco endogenous binder, one or more extrinsic binders that is a tobacco exogenous binder, or a combination thereof to help agglomerate the particulate tobacco. Alternatively, or in addition, sheets of homogenised tobacco material may comprise other additives including, but not limited to, tobacco and non-tobacco fibres, flavourants, fillers, aqueous and non-aqueous solvents and combinations thereof.

Suitable extrinsic binders for inclusion in sheets of homogenised tobacco material for use in aerosol-generating articles comprising a capsule are known in the art and include, but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and 30 pectins; and combinations thereof.

A number of reconstitution processes for producing sheets of homogenised tobacco materials are known in the art. These include, but are not limited to: paper-making processes of the type described in, for example, U.S. Pat. No. 3,860,012; casting or ‘cast leaf’ processes of the type described in, for example, U.S. Pat. No. 5,724,998; dough reconstitution processes of the type described in, for example, U.S. Pat. No. 3,894,544; and extrusion processes of the type described in, for example, in GB-A-983,928. Typically, the densities of sheets of homogenised tobacco material produced by extrusion processes and dough reconstitution processes are greater than the densities of sheets of homogenised tobacco materials produced by casting processes.

Sheets of homogenised tobacco material for use in aerosol-generating articles comprising a capsule are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

The homogenised tobacco sheet material may be produced using different types of tobacco. For example, tobacco sheet material may be formed using tobaccos from a number of different varieties of tobacco, or tobacco from different regions of the tobacco plant, such as leaves or stem. After processing, the sheet has consistent properties and a homogenised flavour. A single sheet of homogenised tobacco material may be produced to have a specific flavour. To produce a product having a different flavour, a different tobacco sheet material needs to be produced. Some flavours that are produced by blending a large number of different shredded tobaccos in a conventional cigarette may be difficult to replicate in a single homogenised tobacco sheet. For example, Virginia tobaccos and Burley tobaccos may need to be processed in different ways to optimise their individual flavours. It may not be possible to replicate a particular blend of Virginia and Burley tobaccos in a single sheet of homogenised tobacco material. As such, the aerosol-generating substrate may comprise a first homogenised tobacco material and a second homogenised tobacco material. By combining two different sheets of tobacco material in a single aerosol-generating substrate, new blends may be created that could not be produced by a single sheet of homogenised tobacco.

The aerosol-former preferably comprises at least one polyhydric alcohol. In a preferred embodiment, the aerosol-former comprises at least one of: triethylene glycol; 1,3-butanediol; propylene glycol; and glycerine.

Features described in relation to one aspect may equally be applied to other aspects of the invention.

The invention will be further described, by way of example only, with reference to the accompanying drawings in which:

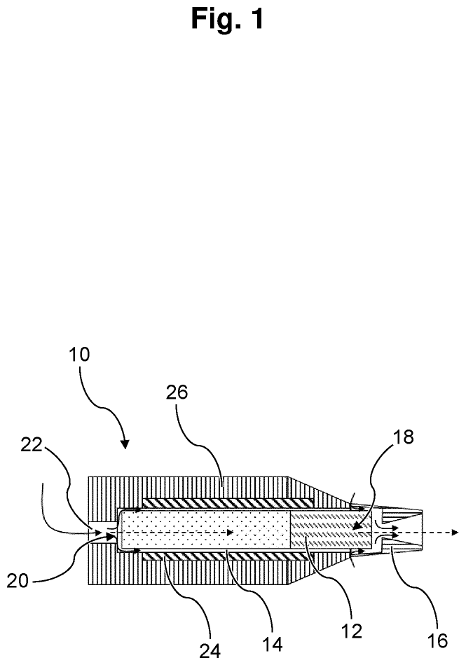

FIG. 1 shows a cross-sectional view of an aerosol-generating device according to the present invention;

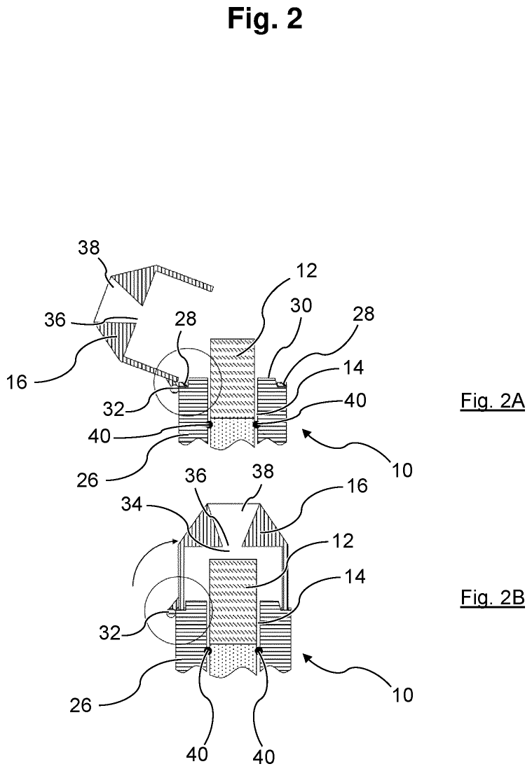

FIG. 2A shows a cross-sectional view of an aerosol-generating device according to the present invention, wherein a mouthpiece of the aerosol-generating device is in an open position;

FIG. 2B shows a cross-sectional view of an aerosol-generating device according to the present invention, wherein a mouthpiece of the aerosol-generating device is in a closed position;

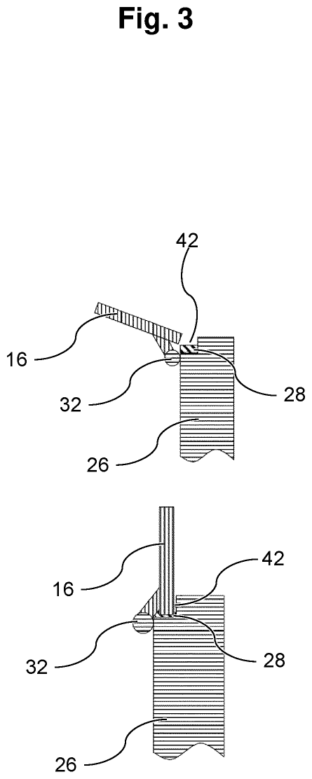

FIG. 3 shows two detailed views of the connection between a mouthpiece and the main body of the aerosol-generating device according to the present invention and of a sealing element of the aerosol-generating device;

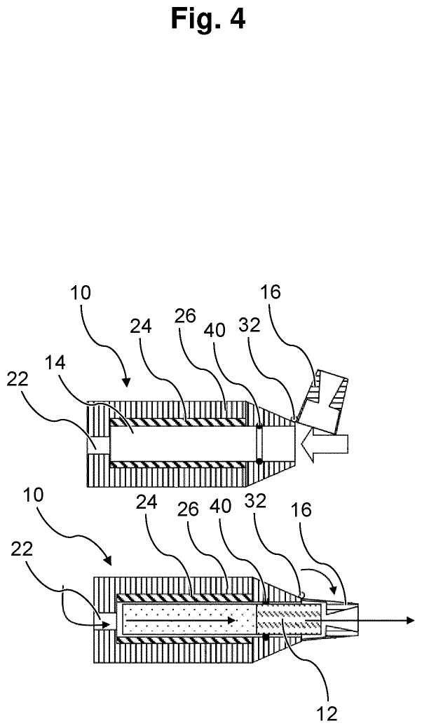

FIG. 4 shows cross sectional views of opened and closed positions of the mouthpiece of the aerosol-generating device; and

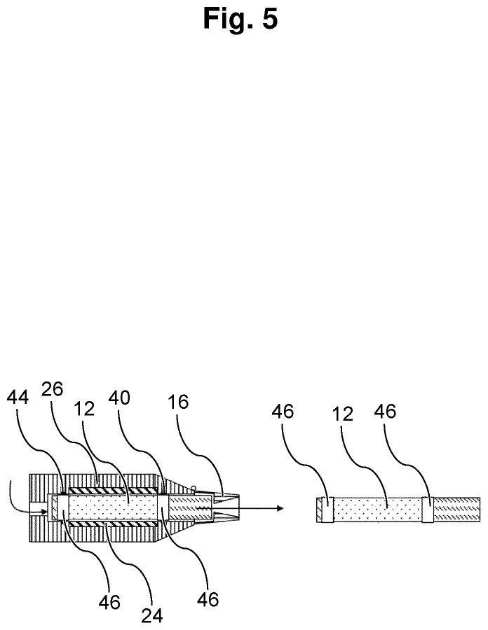

FIG. 5 shows an embodiment of an aerosol-generating system comprising the aerosol-generating device with further sealing elements and an aerosol-generating article with sealing wrappers:

FIG. 1 shows an embodiment of an aerosol-generating device 10. In the aerosol-generating device 10, an aerosol-generating article 12 is inserted into a cavity 14 of the aerosol generating device. A mouthpiece 16 is provided for closing the downstream end 18 of the cavity 14. In the embodiment shown in FIG. 1, the mouthpiece 16 is configured detachable from a main body 26 of the aerosol-generating device 10. In the aerosol-generating device 10, air may flow into the cavity 14 at the upstream end 20 of the cavity 14 as indicated by the arrow. In the cavity 14, air may flow through the aerosol-generating article 12. Further elements depicted in FIG. 1 are an air inlet 22 arranged at the base of the cavity 14, an external heating element 24 arranged around the cavity 14 and a main body 26 of the aerosol-generating device 10.

FIGS. 2A and 2B show an embodiment of the aerosol-generating device 10 according to the present invention. Similar elements of the aerosol-generating device 10 according to the present invention and of the conventional aerosol-generating device 10 are denoted with the same reference signs. Particularly, FIG. 2 shows the main body 26 of the aerosol-generating device 10 as well as the mouthpiece 16. An aerosol-generating article 12 is depicted inserted into the cavity 14 of the main body 26 of the aerosol-generating device 10. Between the main body 26 of the aerosol-generating device 10 and the mouthpiece 16 of the aerosol-generating device 10, a sealing element 28 is arranged. The sealing element 28 is arranged at the downstream end face 30 of the cavity 14 of the main body 26 of the aerosol-generating device 10. The sealing element 28 may be arranged in a groove 42 (see FIG. 3) in the downstream end face 30 of the cavity 14. The sealing element 28 may be arranged adjacent a shoulder at the downstream end face 30 of the cavity 14 as can be seen in FIG. 2A. The sealing element 28 may be arranged radially outward of the shoulder. The sealing element 28 may be arranged around the circumference of the shoulder. The shoulder may be arranged directly adjacent the open downstream end of the cavity 14.

The mouthpiece 16 is pivotally attached to the main body 26 of the aerosol-generating device 10. The attachment between the mouthpiece 16 and the main body 26 of the aerosol-generating device 10 is realized by a hinge 32. The sealing element 28 is arranged between contact surfaces of the mouthpiece 16 and the main body 26 of the aerosol-generating device 10, when the mouthpiece 16 is closed.

FIG. 2A shows the mouthpiece 16 in an opened arrangement. FIG. 2B shows the mouthpiece 16 in a closed arrangement.

The mouthpiece 16 may be dimensioned such that a gap 34 may be provided between the downstream end face 30 of the aerosol-generating article 12 and the mouthpiece 16 when the mouthpiece 16 is closed as shown in FIG. 2B. Hygiene is optimized since a user can draw directly on the mouthpiece 16 instead of on the aerosol-generating article 12. Further, the aerosol-generating article 12 is not damaged or deformed when the mouthpiece is closed by providing the gap 34.

The mouthpiece 16 may comprise a Venturi element. Consequently, the mouthpiece 16 may comprise a constricted airflow passage 36. Downstream of the constricted airflow passage 36, an outlet 38 of the mouthpiece 16 may be provided. The outlet 38 may have a diverging diameter downstream of the constricted airflow passage 36. The aerosol drawn through the mouthpiece 16 may expand in the outlet 38, which may aid aerosol formation and cooling of the aerosol.

In FIGS. 2A and 2B, a second sealing element 40 is depicted. The second sealing element 40 may be arranged at the sidewall of the cavity 14. The second sealing element 40 is configured as an O-ring and is mounted in a groove 42 in the sidewall of the cavity 14. The second sealing element 40 may prevent airflow around the aerosol-generating article 12.

FIG. 3 shows a more detailed view of the hinge 32 as well as of the sealing element 28 (as indicated by the circles in FIGS. 2A and 2B). In the top drawing of FIG. 3, the mouthpiece 16 is positioned in the open position. In bottom drawing of FIG. 3, the mouthpiece 16 is positioned in the closed position. As can be seen in FIG. 3, the sealing element 28 is sandwiched between the mouthpiece 16 and the main body 26 of the aerosol-generating device 10, when the mouthpiece 16 is in the closed position. The sealing element 28 preferably comprises, preferably consists of, a foam material that can be elastically deformed during closing of the mouthpiece 16. After closing of the mouthpiece 16, air flow is prevented between an environment external to the device and the internal airflow path of the device via the junction or interface between the main body 26 of the aerosol-generating device 10 and the mouthpiece 16. FIG. 3 also shows that the sealing element 28 is arranged in a groove 42 in the downstream end face 30 of the cavity 14 of the aerosol-generating device 10.

FIG. 4 shows the aerosol-generating device 10 with open mouthpiece 16 in the top drawing of FIG. 4 and with closed mouthpiece 16 in the bottom drawing of FIG. 4. Additionally, the bottom drawing of FIG. 4 indicates the airflow through the aerosol generating device. The airflow is not diluted by incoming ambient air at the join between the mouthpiece 16 and the device body 26 due to the sealing element 28 between the main body 26 of the aerosol-generating device 10 and the mouthpiece 16. Additionally, the airflow is forced through the aerosol-generating article 12 by providing the second sealing element 40 in the sidewall of the cavity 14. The mouthpiece 16 may comprise a Venturi element. The Venturi element may comprise a constricted airflow passage. The constricted airflow passage may be provided downstream of the gap 34. Downstream of constricted airflow passage, the diameter of the airflow channel through the mouthpiece 16 may increase. The increase in the diameter of the airflow channel may enable the aerosol to expand and cool down, thereby improving aerosol generation.

FIG. 5 shows an embodiment, in which a third sealing element 44 is arranged in the sidewall of the cavity 14 in addition to the second sealing element 40. In this case, the two sealing elements 40, 44 are arranged in a downstream region of the cavity 14 and in an upstream region of the cavity 14, respectively. Additionally, the aerosol-generating article 12 comprises sealing wrappers 46 in addition to a wrapping paper of the aerosol-generating article 12. The sealing wrappers 46 may be arranged around the outer circumference of the aerosol-generating article 12 to increase the outer diameter of the aerosol-generating article 12 in the area of the sealing wrappers 46. The positioning of the sealing wrappers 46 may correspond to the second and third sealing elements 40, 44 of the aerosol-generating article 12. As can be seen on the left part of FIG. 5, when the aerosol-generating article 12 is inserted into the cavity 14 of the aerosol-generating device 10, the sealing wrappers 46 of the aerosol-generating article 12 engage the second and third sealing elements 40, 44 of the aerosol-generating device 10 so that airflow between the sidewall of the cavity 14 and the aerosol-generating article 12 is prevented.

1-15. (canceled)

16. Aerosol-generating system comprising an aerosol-generating device and an aerosol-generating article comprising aerosol-generating substrate, the aerosol-generating device comprising:
a cavity configured to receive the aerosol-generating article comprising aerosol-forming substrate; and
a mouthpiece configured to close the cavity,
wherein the aerosol-generating device is configured such that a gap is provided between the mouthpiece and the aerosol-generating article when the aerosol-generating article is received in the cavity and the mouthpiece is closed, wherein the aerosol-generating device further comprises a first sealing element, wherein the first sealing element is sealingly arranged between the cavity and the mouthpiece and wherein the device comprises a second sealing element arranged at a sidewall of the cavity to provide a seal between the sidewall of the cavity and an aerosol-generating article when the aerosol-generating article is received in the cavity.

17. Aerosol-generating system according to claim 16, wherein the mouthpiece comprises a recessed region to provide the gap between an end face of the aerosol-generating article and the mouthpiece.

18. Aerosol-generating system according to claim 16, wherein the first sealing element is arranged to prevent airflow from an external environment into the device via a boundary between the cavity and the mouthpiece when the mouthpiece is closed.

19. Aerosol-generating system according to claim 16, wherein the first sealing element comprises foam.

20. Aerosol-generating system according to claim 16, wherein the first sealing element is arranged surrounding the downstream end of the cavity.

21. Aerosol-generating system according to claim 16, wherein the first sealing element is ring-shaped.

22. Aerosol-generating system according to claim 16, wherein the mouthpiece is pivotally connected to the aerosol-generating device.

23. Aerosol-generating system according to claim 16, wherein the device comprises a third sealing element arranged at an upstream portion of the cavity, and wherein the second sealing element is arranged at a downstream portion of the cavity.

24. Aerosol-generating system according to claim 23, wherein the second and third sealing elements comprise O-rings.

25. Aerosol-generating system according to claim 16, wherein the aerosol-generating article comprises a wrapping paper around the outer circumference of the aerosol-generating article, and wherein the wrapping paper is configured air impermeable.

26. Aerosol-generating system according to claim 25, wherein the aerosol-generating article comprises a first sealing wrapper, wherein the first sealing wrapper partly covers the wrapping paper and increases the diameter of the aerosol-generating article in the region of the first sealing wrapper.

27. Aerosol-generating system according to claim 26, wherein the aerosol-generating article comprises a second sealing wrapper, wherein the first sealing wrapper is arranged at an upstream portion of the aerosol-generating article and the second sealing wrapper is arranged at a downstream portion of the aerosol-generating article.

28. Aerosol-generating system according to claim 27, wherein the first sealing wrapper of the aerosol-generating article is arranged to sealingly contact the second sealing element of the aerosol-generating device, when the aerosol-generating article is received in the cavity of the aerosol-generating device.

29. Aerosol-generating system according to any of claim 27, wherein the second sealing wrapper of the aerosol-generating article is arranged to sealingly contact the third sealing element of the aerosol-generating device, when the aerosol-generating article is received in the cavity of the aerosol-generating device.

30. Aerosol-generating system according to claim 16, wherein the first sealing element comprises compressible foam.

31. Aerosol-generating system according to claim 16, wherein the first sealing element consists of foam.

32. Aerosol-generating system according to claim 16, wherein the first sealing element consists of compressible foam.
